(19) United States
(12) Patent Application Publication
(10) Pub. No.: US 2010/0188299 A1
(43) Pub. Date: Jul. 29, 2010

(54) Laptop computer antenna device

(75) Inventors: James K. Rinehart, Indianapolis, IN (US); David A. Benedetti, Carmel, IN (US)

Correspondence Address: BODNER & O'ROURKE, LLP, 425 BROADHOLLOW ROAD, SUITE 108, MELVILLE, NY, 11747, US

(73) Assignee: Audiovox Corporation, Hauppauge, NY (US)

(21) Appl. No.: 12/655,798

(22) Filed: Jan. 7, 2010

Related U.S. Application Data
(60) Provisional application No. 61/204,447, filed on Jan. 7, 2009.

(51) Int. Cl. H01Q 1/24

(52) U.S. Cl. 343/702

(57) ABSTRACT

An antenna device for use with a laptop computer includes three foldable sections. A bottom section is hinged to a middle section, and the middle section is hinged to a third section. The laptop computer rests on the bottom section when the middle section is raised to a vertical position. When the laptop is opened, its display may be raised in front of the vertically disposed middle section. The third section is in the form of a planar hoop, which defines a cavity in which an antenna resides for receiving digital broadcast television signals. This third section may be raised from the middle section to a desired position to receive such digital broadcast television signals. The foldable first, second and third sections of the antenna device, whether folded or deployed, is only slightly greater than, equal to or less than the width of the laptop computer so as not to interfere with persons situated adjacent to the user of the laptop computer and antenna device.

### CROSS-REFERENCE TO RELATED APPLICATION

This application is related to U.S. Provisional Application Ser. No. 61/204,447, filed on Jan. 7, 2009, and entitled “Antenna For Use With a Laptop Computer”, the disclosure of which is incorporated herein by reference. This application claims the benefit of priority under 35 U.S.C. 119 and/or 35 U.S.C. 120 to the aforementioned related provisional application.

### BACKGROUND OF THE INVENTION

1. Field of the Invention

The present invention generally relates to antennas for receiving broadcast signals such as television signals, and more specifically relates to antennas for receiving digitally formatted, broadcast television signals. Even more specifically, the present invention relates to antennas for receiving television signals on a laptop computer.

2. Description of the Prior Art

With the transition from analog to digital television, many laptop computers now include a digital television tuner, and for computers that do not include one, external digital TV tuners are available. For receiving such digitally formatted, television broadcast signals, conventionally a telescoping monopole antenna is the most common antenna used in this application. However, such monopole antennas create a problem with respect to where and how it is positioned when a user is watching a television program on his laptop computer. Areas such as an airport terminal or on an airplane or other forms of transportation have limited space, and the telescoping monopole antenna, properly positioned to receive the best signal, may interfere with and be objectionable to another person seated next to the user of the laptop computer.

### OBJECTS AND SUMMARY OF THE INVENTION

It is an object of the present invention to provide an antenna for the reception of digitally formatted, broadcast television signals.

It is another object of the present invention to provide an antenna which is adapted for use with a laptop computer.

It is a further object of the present invention to provide an antenna which is mountable on a laptop computer and which does not extend beyond the width of the laptop computer when deployed so as not to interfere with another person seated adjacent to the user of the laptop computer.

In accordance with one form of the present invention, an antenna device for use with a laptop computer includes three foldable planar sections. The first section, that is, the bottom section, includes upper and lower surfaces. It is preferably hinged to the second section so that the second section may be raised to a vertical or angular position with respect to the first section. The base of the laptop computer rests on the upper surface of the first section when the second section is raised to a vertical position.

The second section of the antenna device, raised to a generally vertical position, is situated behind the raised lid (containing the display) of the laptop computer, again preferably not extending more than the width of the laptop computer cover.

The third second of the antenna device, in its preferred form, is a planar hoop which is pivotally joined to the second section and, ever more preferably, rests in a recess formed in the upper surface of the second section until it is deployed. The hoop defines an internal cavity in which resides the actual antenna for receiving the broadcast television signals.

This third section, comprising the hoop, may be raised from the upper surface of the second section so that the hoop, containing the antenna, may be deployed to a position for receiving the broadcast television signals. Again, the third section preferably, when deployed or undeployed, extends no greater than the width of the laptop computer so as not to interfere with persons adjacent to the user of the laptop computer.

These and other objects, features and advantages of the present invention will be apparent from the following detailed description of illustrative embodiments thereof, which is to be read in connection with the accompanying drawings.

### BRIEF DESCRIPTION OF THE DRAWINGS

FIG. 1 is a front perspective view of a laptop computer situated on the laptop computer antenna device formed in accordance with the present invention.

FIG. 1A is a side perspective view of the laptop computer antenna device constructed in accordance with one form of the present invention and illustrated in an open (deployed) position for use with a laptop computer.

FIG. 1B is a bottom perspective view of the laptop computer antenna device of the present invention in a folded (undeployed) state.

FIG. 2 is a front perspective view of the laptop computer antenna device formed in accordance with the present invention and illustrated in an open (deployed) state for use with a laptop computer.

FIG. 3A is a top, rear perspective view of the laptop computer antenna device formed in accordance with the present invention and illustrated in a folded (undeployed) state.

FIG. 3B is a top plan view of the laptop computer antenna device of the present invention and illustrated in a folded (undeployed) state.

FIG. 3C is a top plan view of the laptop computer antenna device of the present invention and illustrated in an open (deployed) state for use with a laptop computer.

FIG. 3D is a top plan view of the laptop computer antenna device of the present invention in an open (deployed) state and illustrated with a laptop computer resting thereon.

FIG. 4 is a front perspective view of the laptop computer antenna device of the present invention and illustrated in an open (deployed) state for use with a laptop computer

FIG. 5 is a rear perspective view of the laptop computer antenna device of the present invention and illustrated in a folded (undeployed) state.

FIG. 6 is a rear perspective view of the laptop computer antenna device of the present invention and illustrated in an open (deployed) state for use with a laptop computer.

FIG. 7A is a side view of the laptop computer antenna device of the present invention, illustrated in a folded (undeployed) state, adjacent to a laptop computer, also shown in a closed state.

FIG. 7B is a side view of the laptop computer antenna device of the present invention, illustrated in a closed (undeployed) state, adjacent to a laptop computer which is shown in an open state.

FIG. 7C is a side view of the laptop computer antenna device of the present invention, illustrated in a partially open state, and a laptop computer illustrated in an open state resting thereon.

FIG. 7D is a side view of the laptop computer antenna device of the present invention shown in a fully deployed (open) state and a laptop computer resting thereon, and illustrating various positions of a section of the laptop computer antenna device.

FIG. 8 is a bottom plan view of the laptop computer antenna device of the present invention.

FIG. 9 is a top plan view of an antenna, which is preferably formed as an off center fed dipole antenna in a rectangular pattern, having dimensions stated thereon, the antenna forming part of the laptop computer antenna device of the present invention

FIG. 10 is a top plan view of the antenna shown in FIG. 8 and forming part of the laptop computer antenna device of the present invention, with the preferred dimensions of the antenna omitted.

FIG. 11 is a series of radiation patterns measured at certain frequencies (in MHz) in the VHF band for the laptop computer antenna device of the present invention employing the antenna shown in FIGS. 10 and 11, when a section of the laptop computer antenna device in which the antenna is situated is disposed in a horizontal position.

FIG. 12 is a series of radiation patterns measured at certain frequencies (in MHz) in the VHF band for the laptop computer antenna device of the present invention employing the antenna shown in FIGS. 10 and 11, when a section of the laptop computer antenna device in which the antenna is situated is disposed in a vertical position.

FIG. 13 is a series of radiation patterns measured at certain frequencies (in MHz) in the UHF band for the laptop computer antenna device of the present invention employing the antenna shown in FIGS. 10 and 11, when a section of the laptop computer antenna device in which the antenna is situated is disposed in a horizontal position.

FIG. 14 is a series of radiation patterns measured at certain frequencies (in MHz) in the UHF band for the laptop computer antenna device of the present invention employing the antenna shown in FIGS. 10 and 11, when a section of the laptop computer antenna device in which the antenna is situated is disposed in a vertical position.

FIG. 15 is a graph of VSWR (voltage standing wave ratio) measured against frequency (in MHz) for the antenna of the present invention shown in FIGS. 9 and 10 used in the laptop computer antenna device of the present invention.

FIG. 16 is a graph of gain (in dBi) measured against frequency (in MHz) in the VHF band for the antenna of the present invention shown in FIGS. 9 and 10 used in the laptop computer antenna device of the present invention, when the segment of the laptop computer antenna device in which the antenna is situated is disposed in a vertical position and a horizontal position.

FIG. 17 is a graph of gain (in dBi) measured against frequency (in MHz) in the UHF band for the antenna of the present invention shown in FIGS. 9 and 10 used in the laptop computer antenna device of the present invention, when the segment of the laptop computer antenna device in which the antenna is situated is disposed in a vertical position and a horizontal position.

FIG. 18A is a top plan view of a preamplifier used in the laptop computer antenna device of the present invention.

FIG. 18B is a front side view of the preamplifier shown in FIG. 18A used in the laptop computer antenna device of the present invention.

FIG. 18C is a left lateral view of the preamplifier shown in FIGS. 18A and 18B used in the laptop computer antenna device of the present invention.

FIG. 18D is a right lateral view of the preamplifier shown in FIGS. 18A, 18B and 18c used in the laptop computer antenna device of the present invention.

FIG. 19 is a front perspective view of a laptop antenna computer device constructed in accordance of another form of the present invention, and shown in an open (deployed) state for use with a laptop computer.

FIG. 20 is a bottom perspective view of the laptop computer antenna device of the present invention shown in FIG. 19 and illustrated in an open (deployed) state for use with a laptop computer.

FIG. 21 is a top perspective view of the laptop computer antenna device of the present invention shown in FIG. 19 and illustrated in a folded (undeployed) state.

FIG. 22 is a front view of the laptop computer antenna device of the present invention shown in FIG. 21 and illustrated in a folded (undeployed) state.

FIG. 23 is a bottom perspective view of the laptop computer antenna device of the present invention shown in FIGS. 21 and 22 and illustrated in a folded (undeployed) state.

FIG. 24 is a side view of the laptop computer antenna device of the present invention shown in FIG. 23 and illustrated in a folded (undeployed) state.

FIG. 25 is a rear view of the laptop computer antenna device shown in FIG. 23 and illustrated in a folded (undeployed) state.

FIG. 26 is a bottom plan view of the laptop computer antenna device of the present invention shown in FIGS. 23-25 and illustrated in a folded (undeployed) state.

### DETAILED DESCRIPTION OF THE PREFERRED EMBODIMENTS

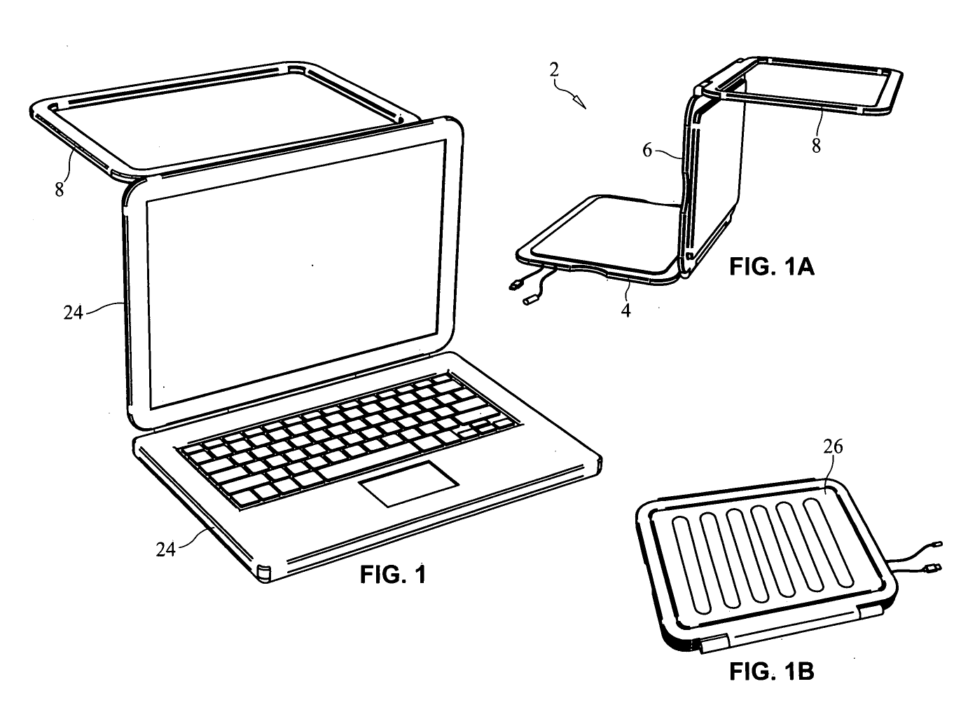

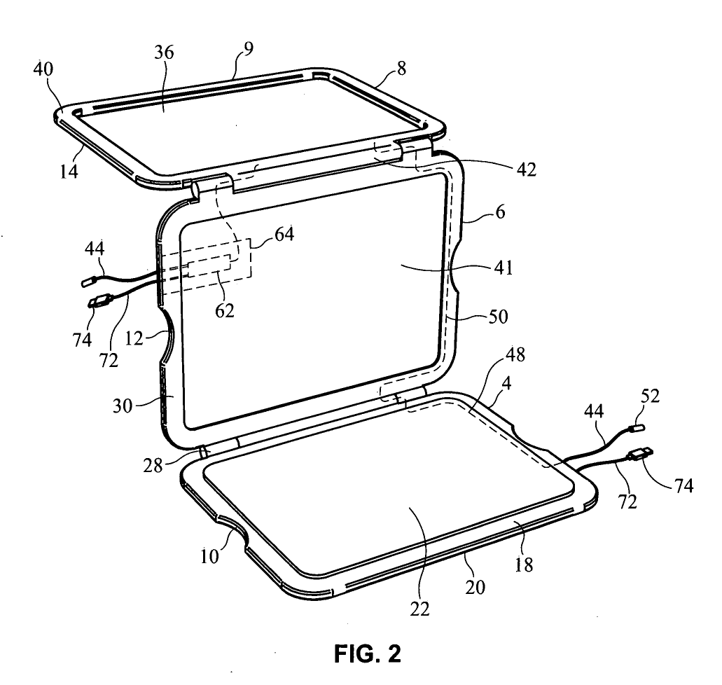

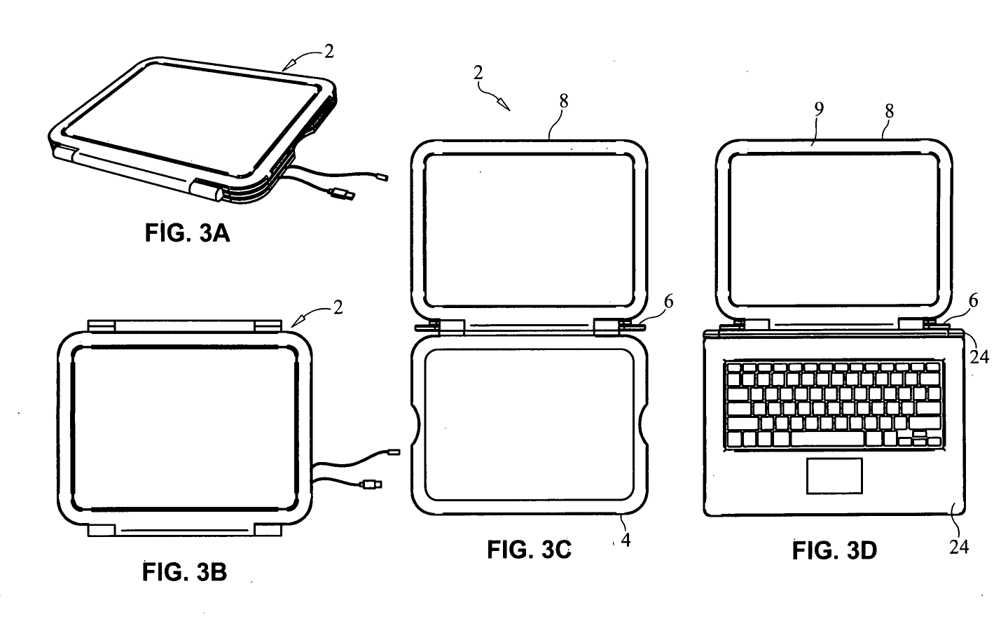

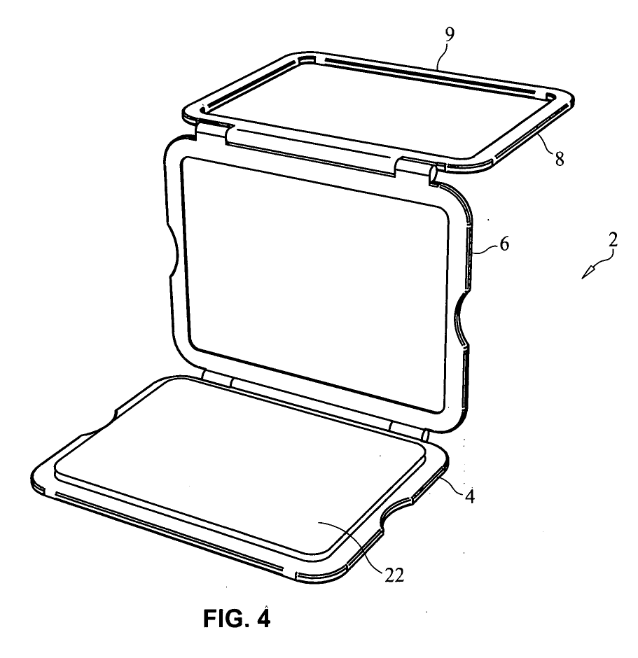

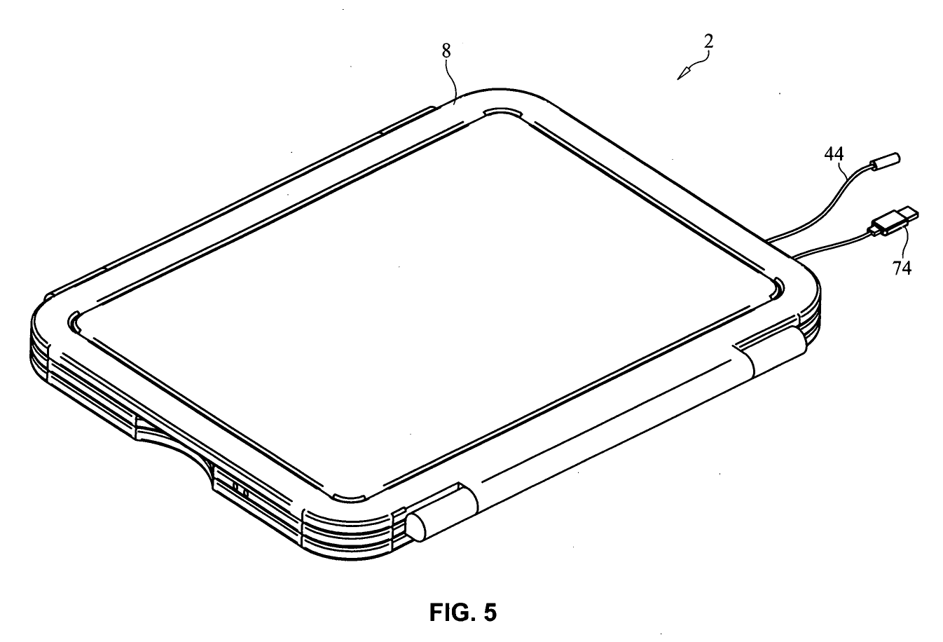

Referring initially to FIGS. 1-6 of the drawings, it will be seen that a mobile digital laptop computer antenna device 2 constructed in accordance with the present invention, includes three generally planar sections—a bottom section 4, a middle section 6 which is hingedly joined to the bottom section 4, and a third or top section 8 which is hingedly joined to the middle section 6.

The three sections 4, 6, 8 may be folded down on top of each other to a compact, generally planar form so that it is convenient to carry. The lateral edges of the bottom section 4 include recessed portions 10, and the lateral edges of the middle section 6 also include recessed portions 12, which are in alignment with the recessed portions 10 of the bottom section 4 and which are preferably recessed less than the recessed portions 10 of the bottom section 4 so that a user may easily reach into the recessed portions 10 of the bottom section 4 with his fingers to lift the exposed lateral edges of the middle section 6 at the recessed portions 12 thereof to unfold the sections 4, 6, 8 of the laptop antenna device 2 and raise the middle section 6 from the bottom section 4. The third or top section 8, which is preferably formed as a rectangular hoop 9, is hingedly attached to the middle section 6, and it has lateral edges 14 which are exposed for the user to grasp through the recessed portions 12, 10 of the middle section 6 and the bottom section 4 so that the third section 8, which includes the actual broadcast television receiving antenna 16, may be raised from the surface of the middle section 6 and so that the antenna 16 may be deployed to receive broadcast television signals.

More specifically, the bottom section 4 of the laptop computer antenna device 2 formed in accordance with the present invention includes an upper surface 18 and an opposite lower surface 20. The upper surface 18 preferably has an anti-slip foam padding 22 attached thereto to prevent or minimize the slippage of the laptop computer 24 off the unfolded antenna device 2 when the bottom of the laptop computer 24 is resting on the foam padding 22 on the upper surface 18 of the bottom section 4. Alternatively, mating Velcro™ hook and loop fasteners (not shown) may be adhesively mounted on the upper surface 18 of the bottom section 4 of the laptop computer antenna device 2, with a mating fastener (not shown) adhesively mounted to the bottom of the laptop computer's base so that the laptop computer 24 may be removably secured to the upper surface 18 of the bottom section 4 when the laptop computer antenna device 2 of the present invention is unfolded and the laptop computer 24 is resting thereon.

The lower surface 20 of the bottom section 4 of the laptop computer antenna device 2 of the present invention preferably includes a series of parallel ribs 26 extending from the surface thereof, which ribs 26 are provided to minimize slippage of the laptop computer antenna device 2 off a user's lap when the laptop computer antenna device is being used.

As can be seen from FIGS. 1-6 of the drawings, the upper edge of the bottom section 4 of the mobile digital laptop computer antenna device 2 is joined to the bottom edge of the middle section 6 by a hinge 28 so that the middle section 6 may be pivoted from a position where the lower surface 30 of the middle section 6 is resting against or in proximity to the upper surface 18 of the bottom section 4 to a position where the middle section 6 is angularly disposed, such as generally vertically disposed, from the bottom section 4, which when being used will be resting on the person's lap or tabletop in a horizontal position.

The middle section 6 of the laptop computer antenna device 2 of the present invention has a lower surface 30, as mentioned previously, as well as an opposite upper surface 32. Like the bottom section 4, the middle section 6 is planar and rectangular in shape, having overall dimensions that are the same as or similar to those of the bottom section 4.

The middle section 6, on its upper surface 32, preferably includes a recessed portion 34 extending about its periphery. The recessed portion 34 defines a recess in the upper surface 32 of the middle section 6 of the mobile digital laptop computer antenna device 2 for receiving the third section 8 which, preferably, is in the form of a continuous rectangular, planar hoop 9 having a central opening 36 formed through the thickness thereof, which hoop 9 is received by the recess and rests against the recessed portion 34 of the upper surface 32 of the middle section 6. The non-recessed portion 38 of the upper surface 32 of the middle section 6 is received within the central opening 36 defined by the hoop 9 of the third section 8 so that, when the third section 8 (the hoop 9) is folded flat against the middle section 6, the upper surface 40 of the third section 8 resides in the same plane as the non-recessed portion 38 of the upper surface 32 of the middle section 6 to provide the mobile digital laptop computer antenna device 2 of the present invention with a finished, compact look. The lower surface 30 of the middle section 6 may also be formed with a central recessed portion 41 to define a recess that receives the foam padding 22 situated on the upper surface 18 of the bottom section 4.

The third section 8 of the laptop computer antenna device 2 has a lower edge which is pivotally joined to the upper edge of the middle section 6 by a hinge 42 to allow the third section 8 to be folded against the upper surface 32 of the middle section 6 and to be unfolded therefrom so that the plane in which the third section 8 generally resides is at an angle to the plane in which the middle section 6 generally resides. The third section 8 (the hoop 9) includes a cavity formed therein in which the signal receiving antenna 16 resides. When the third section 8 is unfolded from the middle section 6 and positioned at an angle thereto, preferably in a generally horizontal position while the middle section 6 is positioned in a generally vertical position, the actual antenna 16 (or antenna element or elements, to be more precise) is now deployed at a particular angle to provide good reception of broadcast TV signals.

The antenna 16 (or antenna elements) which is situated within the third section 8 of the mobile digital laptop antenna device 2 is electrically coupled to a coaxial cable or other electrical conductor 44 extending from either the bottom section 4, the middle section 6 or the third section 8 of the mobile digital laptop computer antenna device 2. In one form of the present invention, the coaxial cable 44 enters one of the lateral edges of the bottom section 4 or is coupled to a connector 46 on one of the lateral edges, and either the coaxial cable 44 or the connector 46 is connected to a flexible conductor or coaxial cable 48 which passes through the hinge 28 interconnecting the bottom section 4 with the middle section 6, and through another conductor or coaxial cable 50 which passes through the height of the middle section 6 and which passes through the hinge 42 interconnecting the middle section 6 with the third hoop section 8. A portion of the conductor 50 in the third hoop section 8 connects to the antenna 16 situated within third section 8. The coaxial cable 44 may be connected to the bottom section 4 (or for that matter, any of the other sections 6, 8) of the mobile digital laptop computer antenna device 2 of the present invention with an appropriate mating connector 46, and may be connected to the TV input connector (not shown) of the laptop computer 24 using an appropriate mating connector 52. Alternatively, the coaxial cable 44 from the mobile digital laptop computer antenna device 2 may be connected to an adaptor (not shown) which may be used to interface with a USB port (not shown) on the laptop computer 24. Or, in another alternative form of the present invention, the coaxial cable 44 from the mobile digital laptop computer antenna device may be connected to an external DTV tuner (not shown), which in turn may be connected to the laptop computer 24.

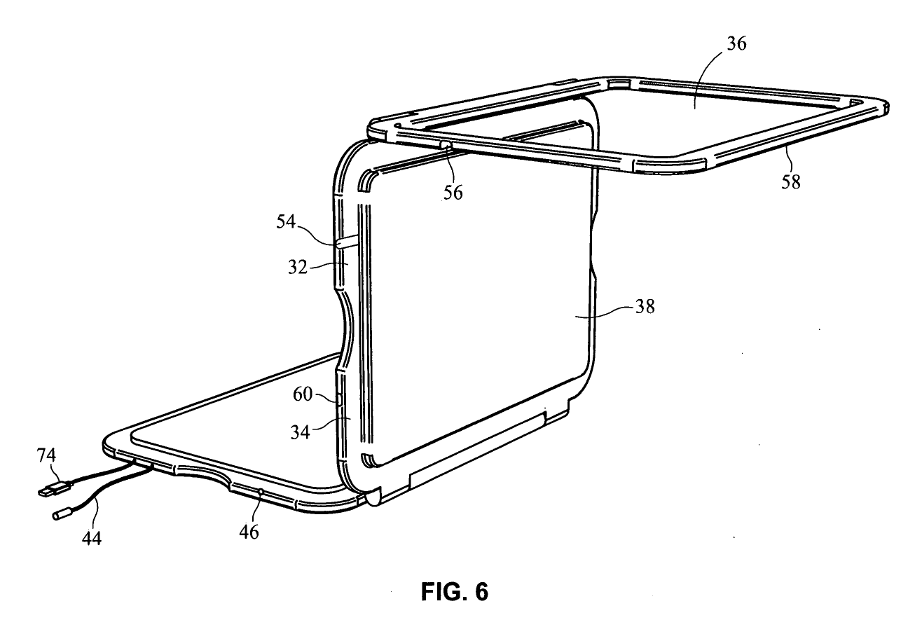

In a preferred form of the invention, and as shown in FIG. 6 of the drawings, the coaxial cable 44 at one end includes a connector 52 for connection to the laptop computer 24 or an external DTV tuner (not shown) and at the other end is partially received in aligned recesses 54, 56 formed in the upper surface 32 and at a lateral side of the recessed portion 34 of the middle section 6 and in the lower surface 58 of the third hoop section 8 so as not to interfere with the third hoop section 8 being closed flat against the middle section 6. Alternatively, the coaxial cable 44 may terminate in a connector (not shown), which is connectable to a mating connector 60 mounted to the middle section 6 and residing in the recess of the middle section. The coaxial cable 44 (or another cable coupled to the mating connector 60 on the middle section 6) passes through the interior of the middle section 6 and into the third hoop section 8 for electrically connecting to the signal receiving antenna 16 housed within the third section 8.

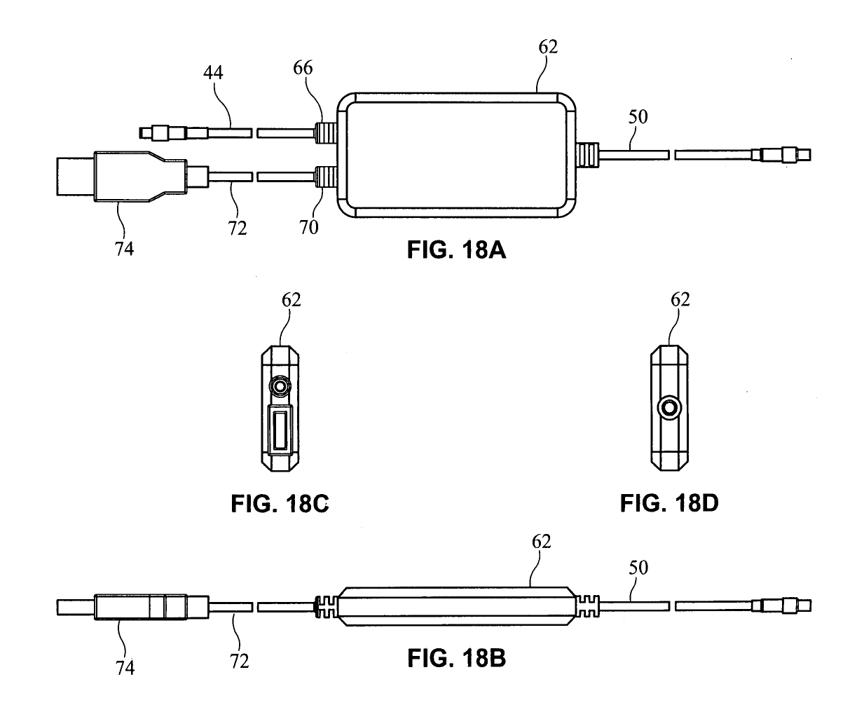

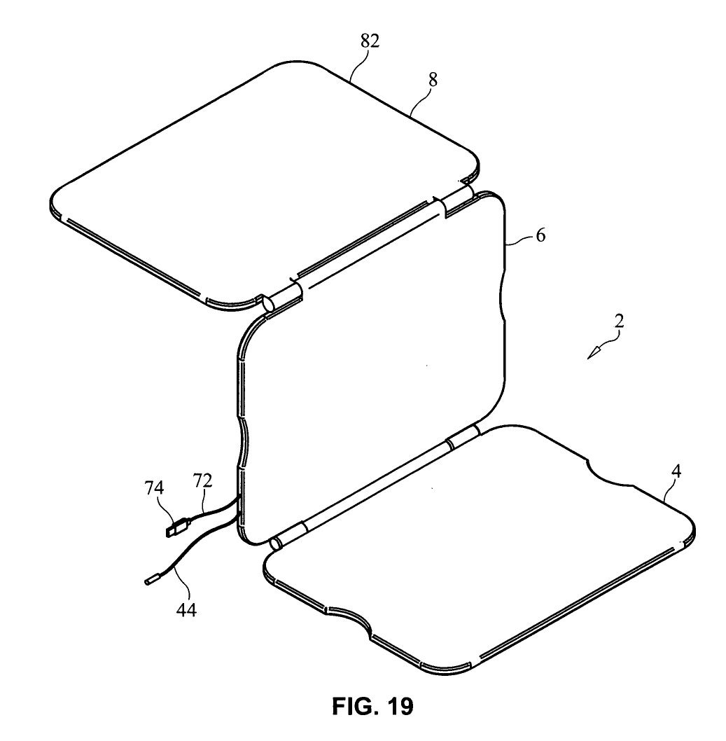

In yet another form of the present invention, and as shown in FIGS. 18A-18D and 19 of the drawings, the laptop computer antenna device 2 may include a preamplifier 62 to help improve reception of broadcast television signals in weak signal locations. The preamplifier 62 is preferably housed in a cavity 64 within the interior of the middle section 6 of the antenna device 2, although it is envisioned to be within the scope of the present invention to alternatively mount the preamplifier 62 to the first bottom section 4 or the third top section 8 of the antenna device 2. The preamplifier 62 has an input port 66 which is connected to the coaxial cable 50 that passes through the middle section 6 and into the third hoop section 8, and is connected to the signal receiving antenna. The broadcast television signals received by the antenna 16 are, therefore, provided to the preamplifier 62 on its input port 66, and are amplified. The amplified signals are provided on an output port 68 of the preamplifier 62, which output port 68 is coupled to the coaxial cable 44 extending from the middle section 6 and provided for connection to the laptop computer 24 or another device, such as a DTV tuner. The preamplifier 62 is preferably powered from the +5 volt DC power provided on the USB port of the laptop computer 24, although another external power source could be used to power the preamplifier 62. Thus, the preamplifier 62 includes a power input port 70 which is connected to a cable 72 which extends from the middle section 6 and has at its opposite end a USB connector 74 for mating with the USB connector on the laptop computer 24 in order to provide power to the preamplifier 62 from the laptop computer 24. The gain of the preamplifier 62 is preferably about 12 dB.

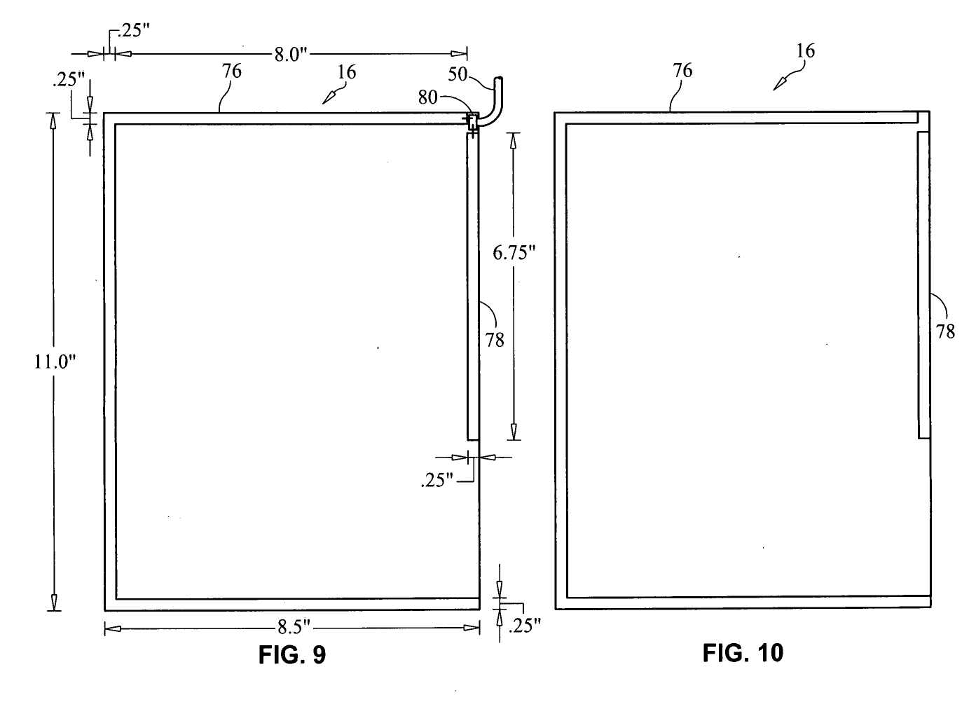

As shown in FIGS. 9 and 10 of the drawings, the antenna 16 housed by the third section 8 of the mobile digital laptop computer antenna device 2 may include a pair of antenna elements 76, 78 configured as an off-center fed dipole (or modified loop) antenna having an overall rectangular shape. Each element 76, 78 may be made of a conductive coating or ink, metal foil or metal braid situated within the third section 8 of the overall antenna device 2. The antenna 16 is preferably an off-center fed dipole (or modified loop) antenna to provide wide bandwidth performance. The feed point is optimized for wide band operation and to provide a particular feed point impedance.

A balun 80 may be used and connected at the dipole feed point, with the other end of the balun connected to a 75 ohm coaxial cable 50. The balun 80 provides impedance matching and decoupling and, as mentioned previously, the other end of the coaxial cable 50 (or an associated coaxial cable 44 coupled thereto) would be connected to the antenna input on the computer 24 or to an external DTV tuner. The antenna 2 and its antenna elements 76, 78 are shown in FIG. 10 and preferably has the dimensions shown in FIG. 9. The antenna elements 76, 78 may be formed as copper etchings or lands on a printed circuit board, which printed circuit board and copper antenna elements 76, 78 are housed within the cavity defined by the third section 8. Alternatively, the antenna elements 76, 78 may be formed from a thin sheet of brass or other electrically conductive material, and even more preferably, sandwiched between two thin layers of a non-electrically conductive material, such as Mylar™, with the Mylar™ encased antenna being situated within the cavity defined by the third section 8. Of course, it should be realized that the antenna pattern and dimensions are affected by the material the antenna 16 is made from and the dielectric of the material that the antenna 16 is mounted on.

It can be seen from FIGS. 9 and 10 that the size of the dipole (or modified loop) antenna 16 is about 11 inches by 8.5 inches in its preferred form, and thus preferably does not extend beyond the width of most if not all laptop computers 24. Alternatively, the antenna device 2 may extend beyond the laptop computer 24 with which it is used, but not to the extent where it interferes with persons seated next to the user of the laptop computer 24 and antenna device 2, or within the seating space provided to the user. In one embodiment, the overall width of the laptop computer antenna device 2 is equal to or less than about 20 inches.

Alternatively, the antenna 16 may be a loop (or hoop) antenna housed within the third section 8 of the mobile digital laptop antenna device 2 of the present invention. The loop (or hoop) antenna 16 may be formed from a continuous, relatively narrow sheet of copper or other metal in a preferably rectangular shape extending about the periphery of the third section 8 within the internal cavity thereof, or may be a plurality of windings of wire wrapped generally about the periphery of the third section 8 within the cavity thereof.

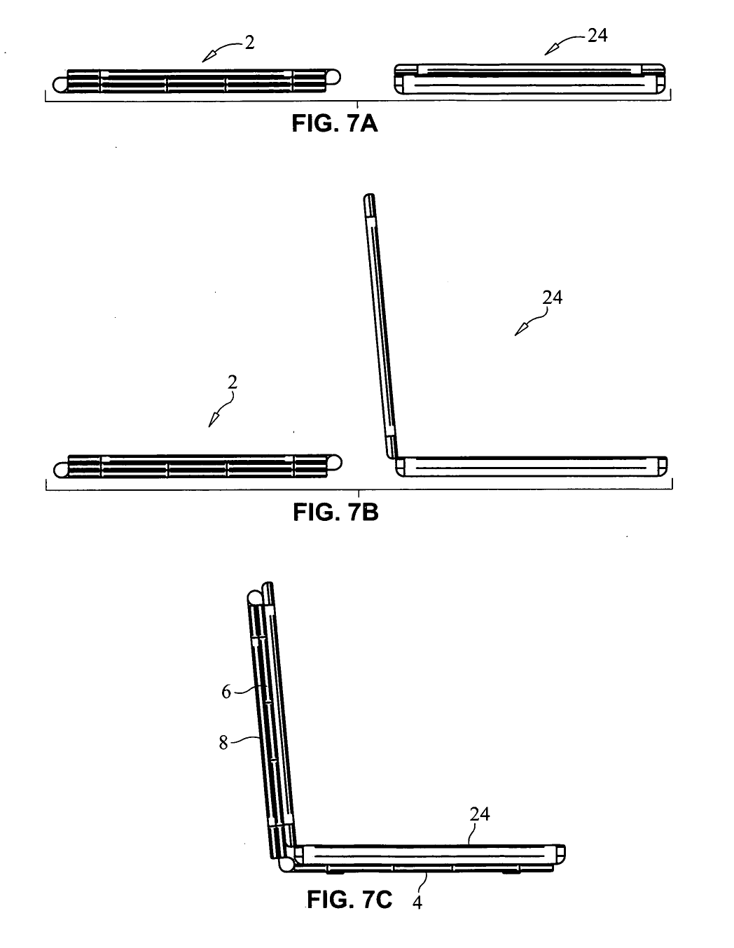

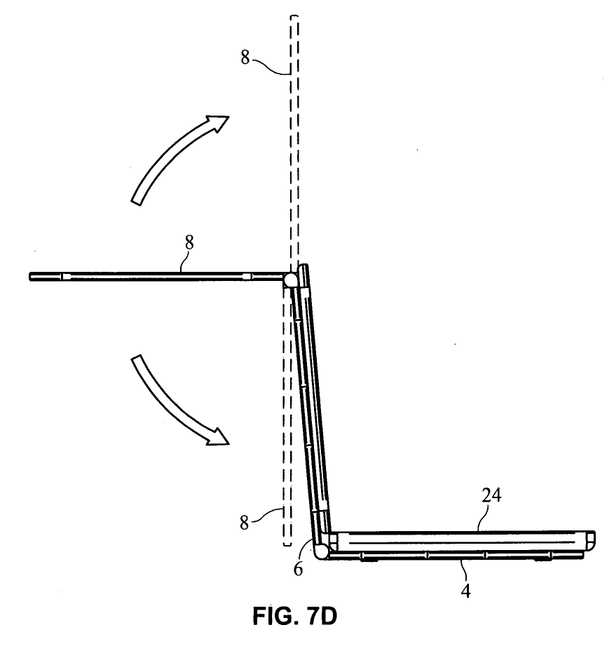

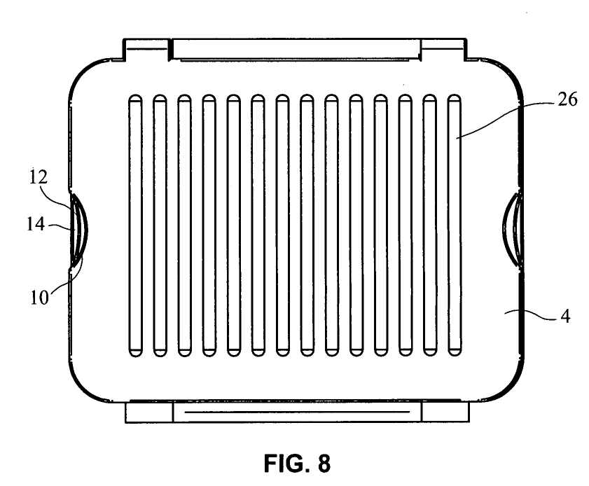

FIGS. 7A-7D illustrate the steps in using the mobile digital laptop computer antenna device 2 of the present invention in conjunction with a laptop computer 24. In FIG. 7A, both the antenna device 2 and the laptop computer 24 are in a closed position. In FIG. 7B, the laptop computer 24 is opened for usage by raising the lid thereof from the base of the laptop computer. As shown in FIG. 7C, the middle section 6 of the mobile digital laptop computer antenna device 2 of the present invention is raised from the bottom section 4 and the antenna device 2 is placed under and behind the base and lid of the laptop computer 24, with the base of the laptop computer resting on the foam padding 22 situated on the upper surface 18 of the bottom section 4, and the lower surface 30 of the middle section 6 resting against or in proximity to (and facing) the top surface of the lid of the laptop computer 24. Then, as shown in FIG. 7D, the antenna hoop element 9 (i.e., the third section 8) is raised out of the recess formed in the upper surface 32 of the middle section 6 and positioned at a particular angle to the middle section 6 to provide the best reception for high definition television signals.

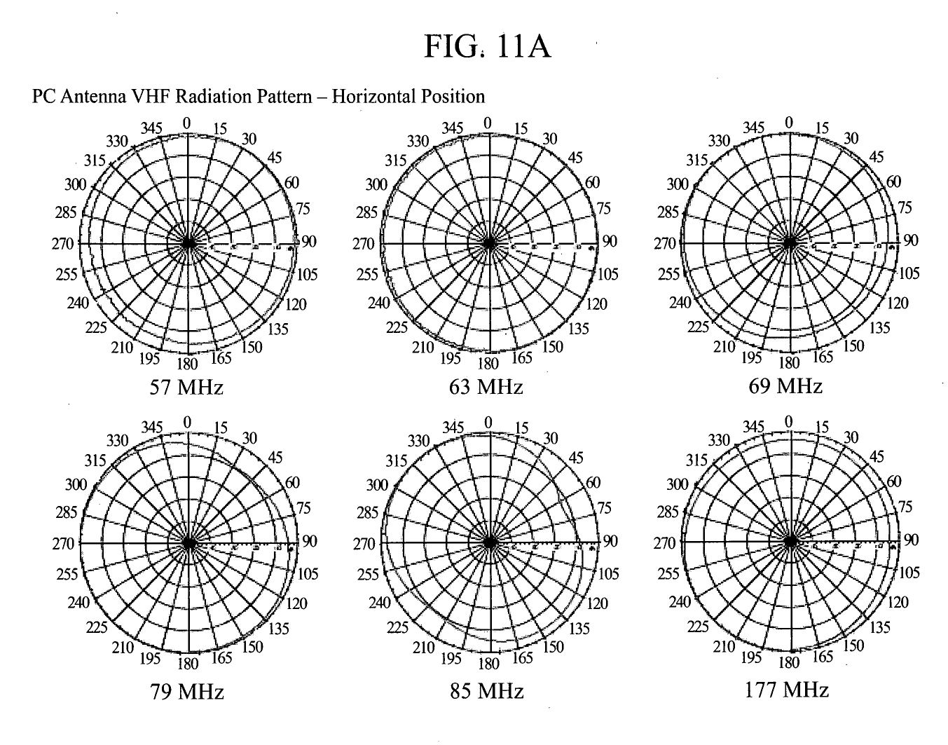

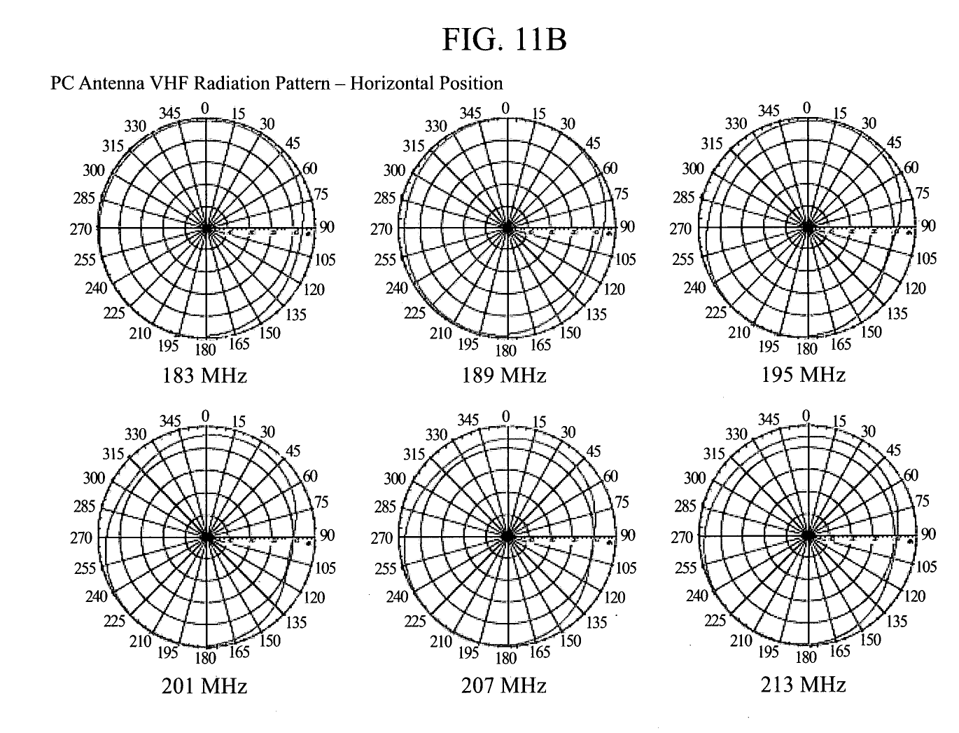

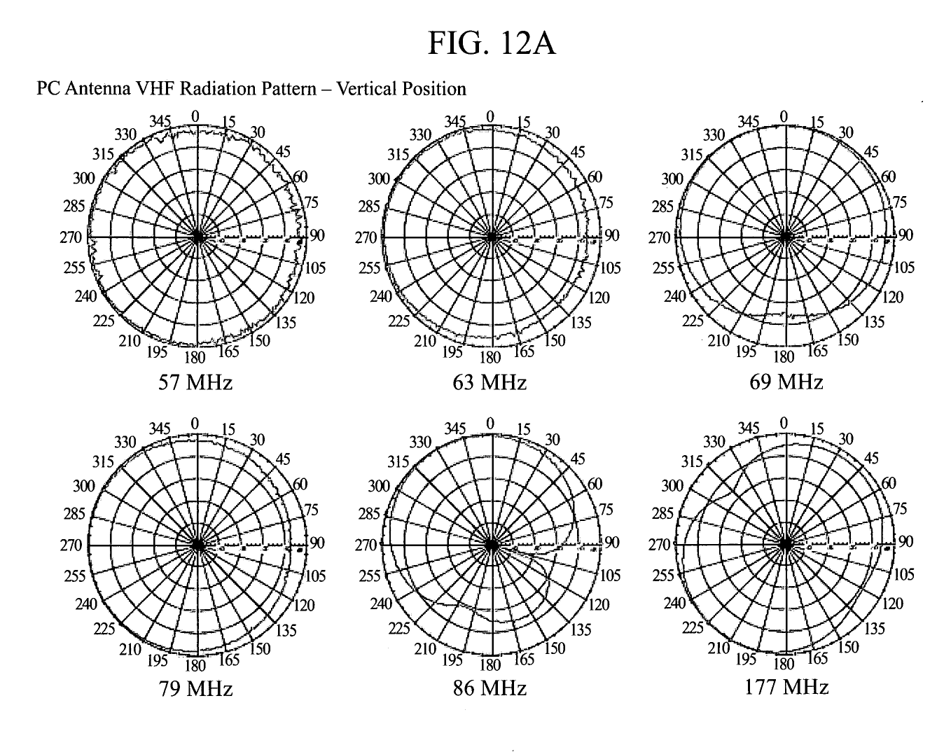

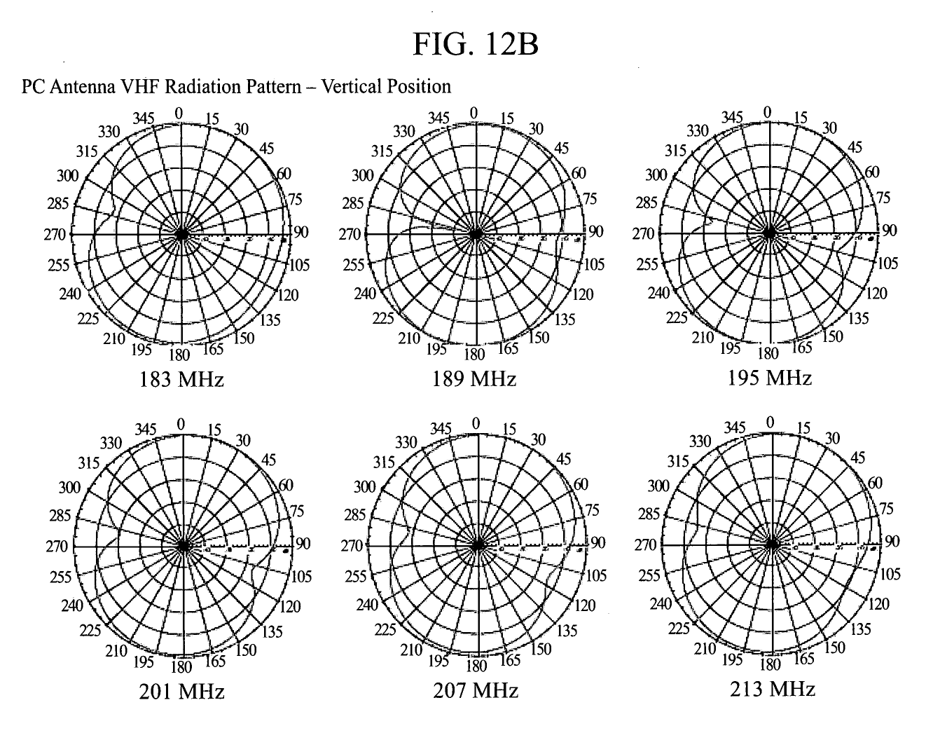

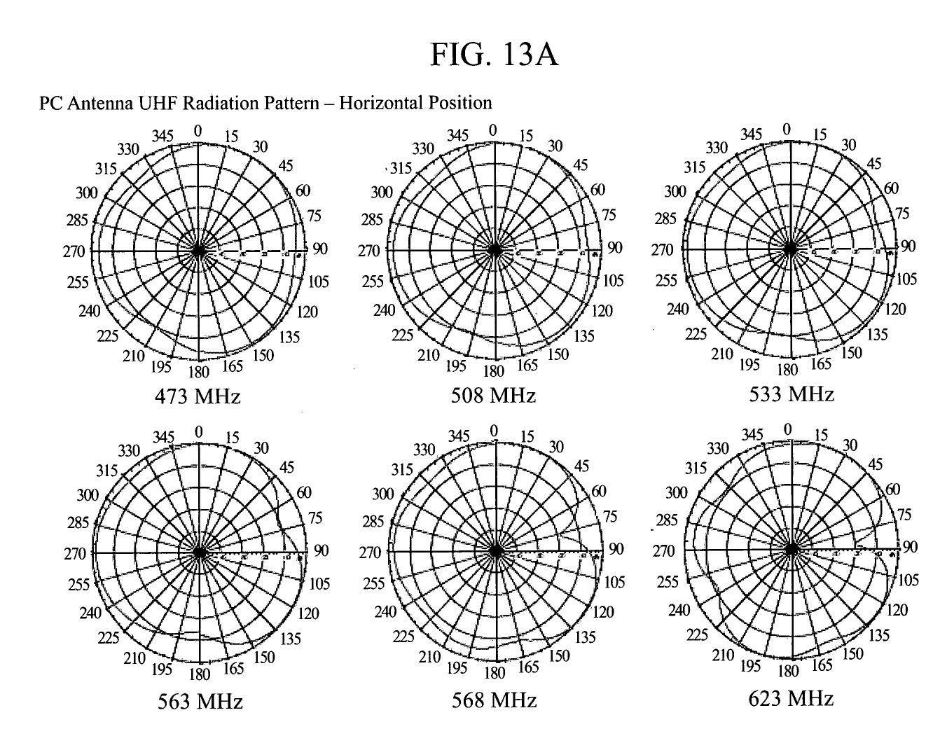

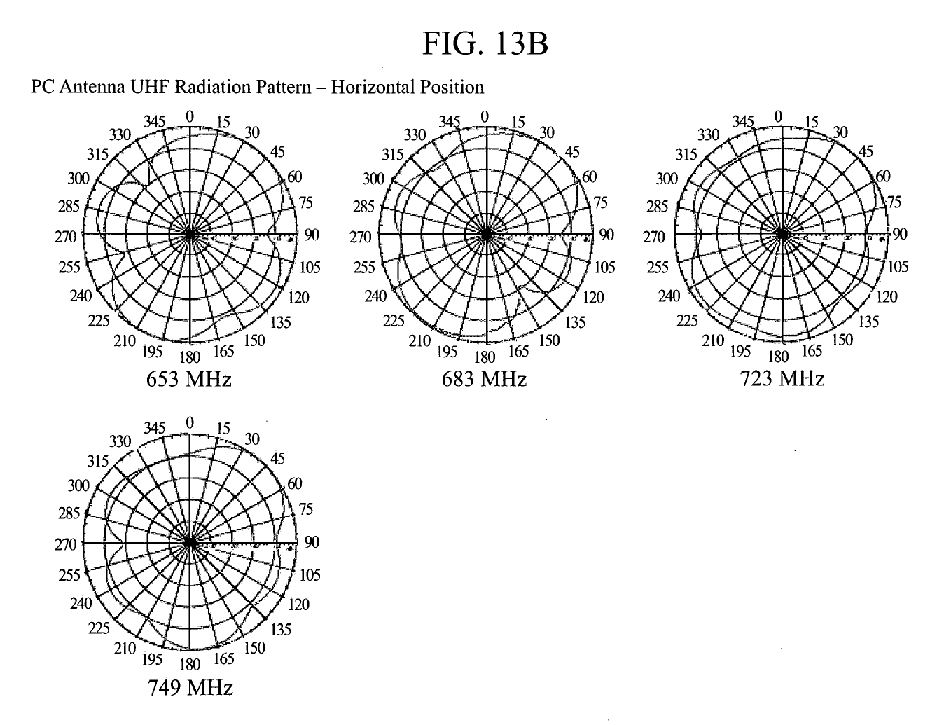

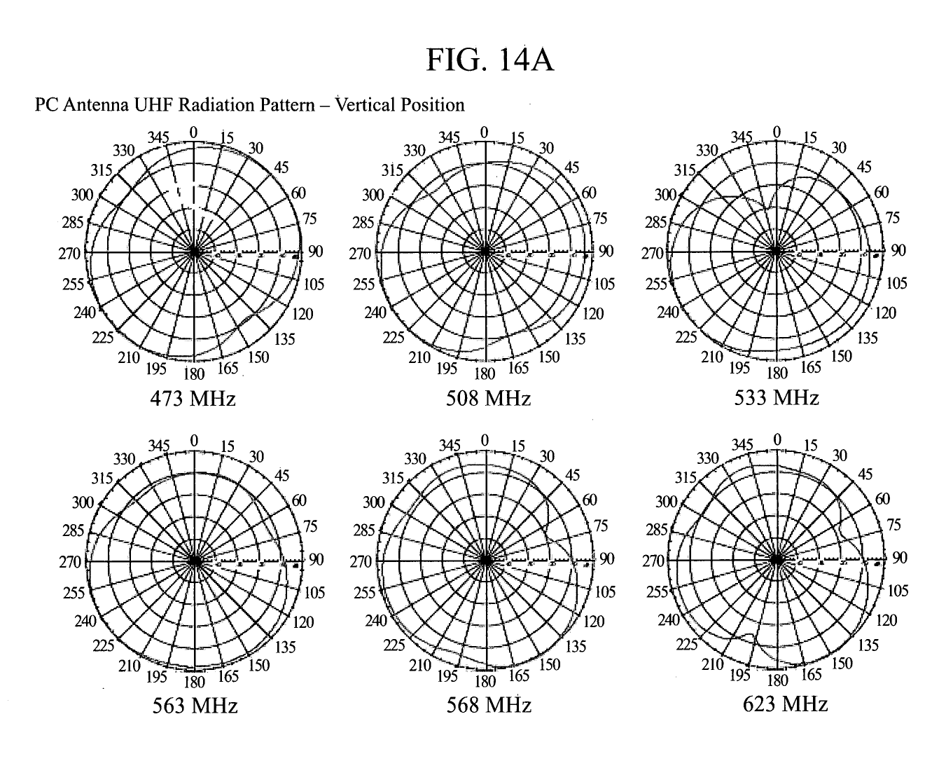

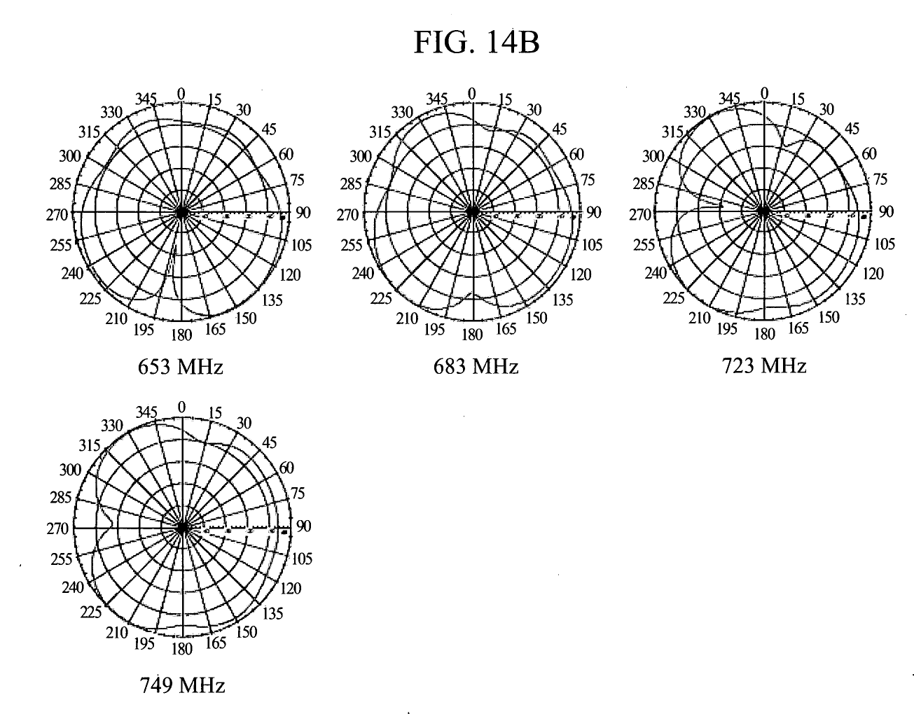

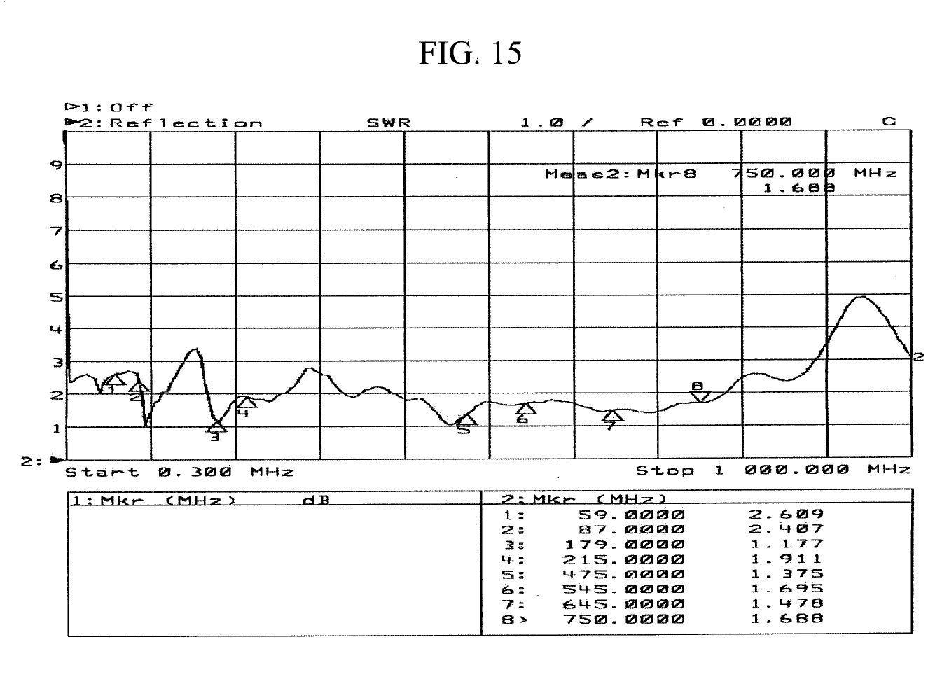

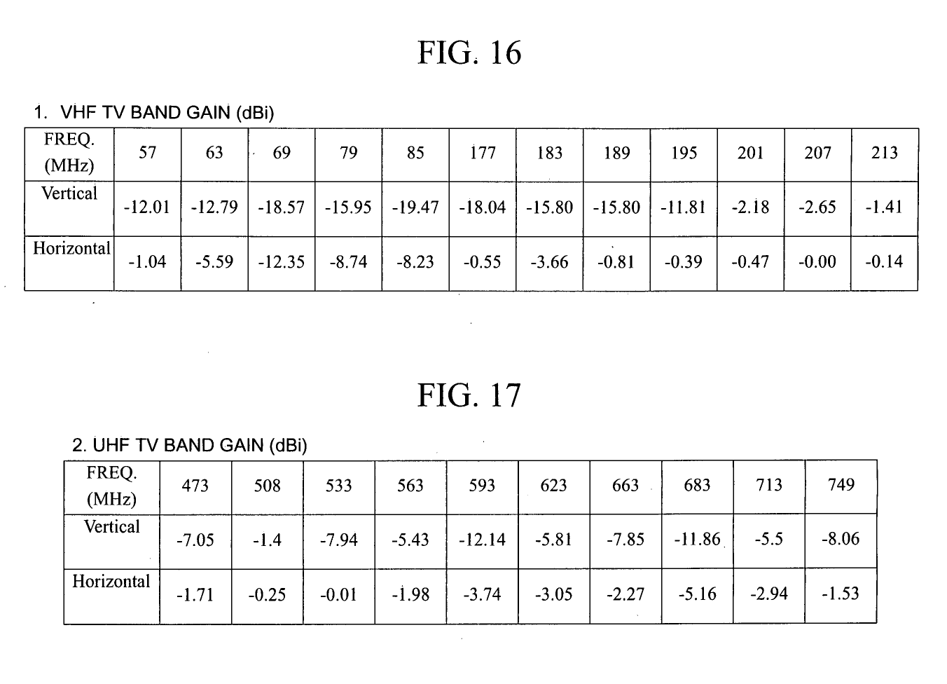

FIGS. 11-14 show the radiation patterns at certain frequencies for the antenna 16 shown in FIGS. 10 and 11 and used in the laptop computer antenna device 2 of the present invention, FIG. 15 is a graph of the voltage standing wave ratio for the same antenna 16 shown in FIGS. 9 and 10, and FIGS. 16 and 17 are graphs of the gain of the antenna shown in FIGS. 9 and 10.

It should be noted that the third section 8 of the mobile digital laptop computer antenna device 2 of the present invention preferably extends only behind the lid of the laptop computer 24 and preferably does not extend beyond the width thereof and thus does not extend into the space provided for, or interfere with, a person seated adjacent to the user of the laptop computer 24 and the mobile digital laptop computer antenna device 2 of the present invention. It can further be seen that the mobile digital laptop computer antenna device 2 of the present invention may be conveniently folded to a compact, generally planar state for ease of use and convenience in transporting the antenna device 2.

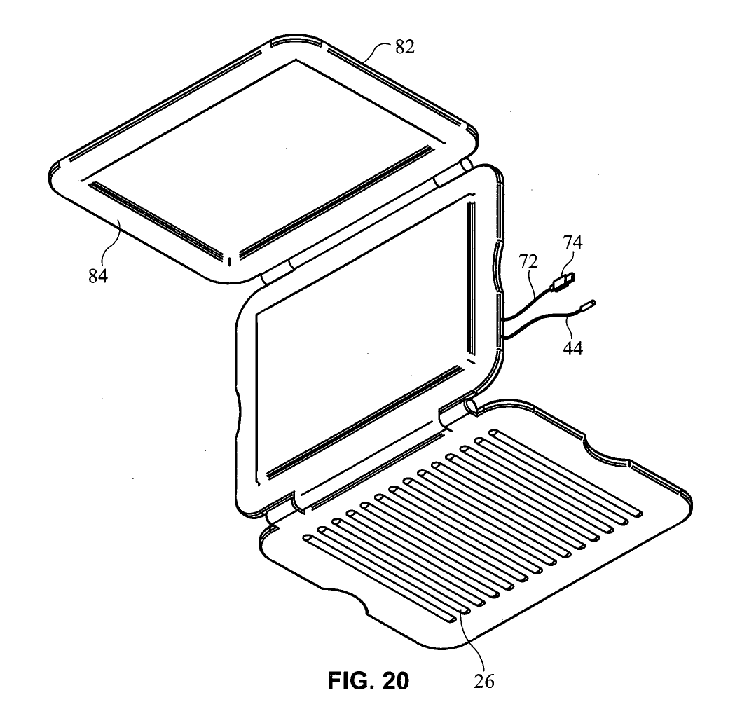

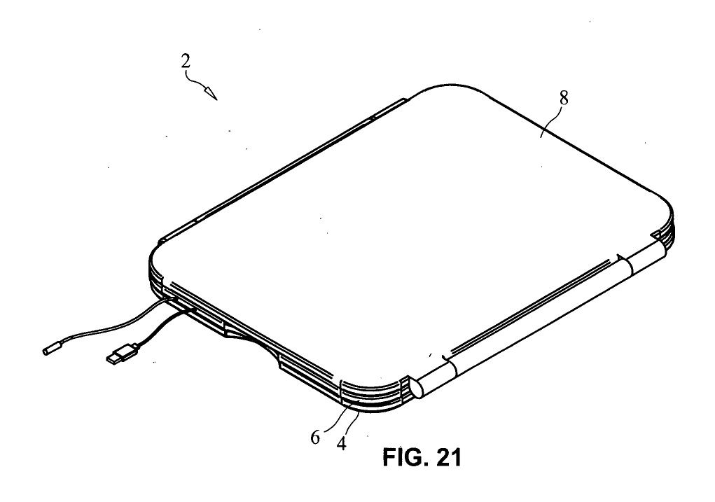

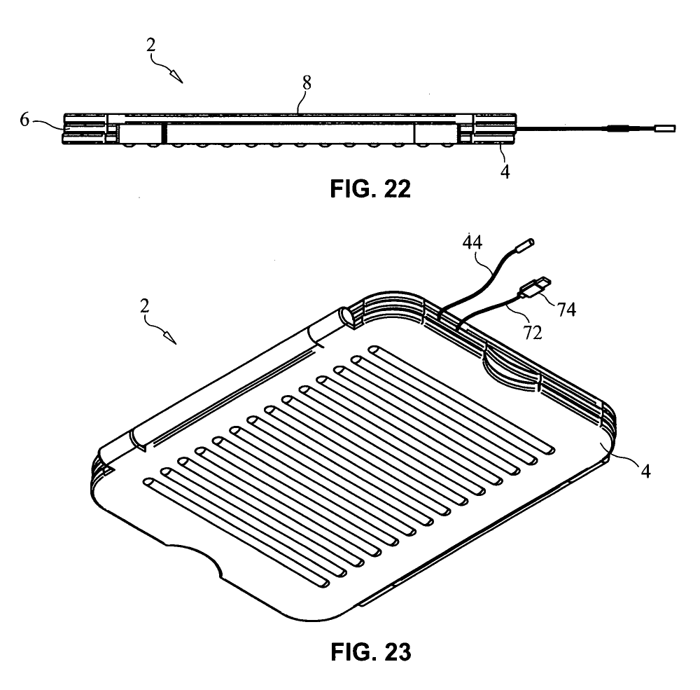

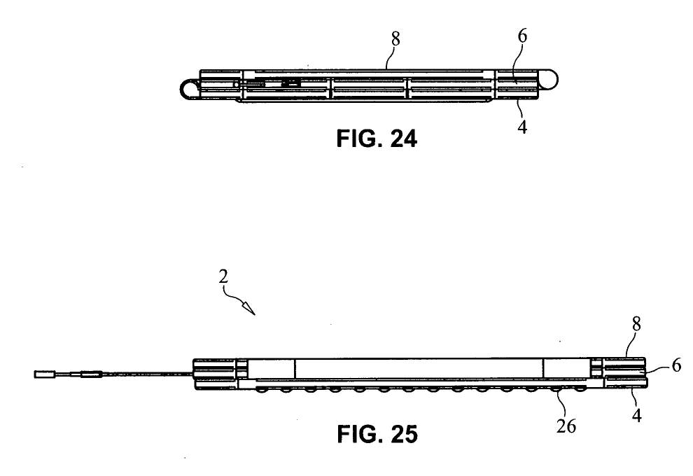

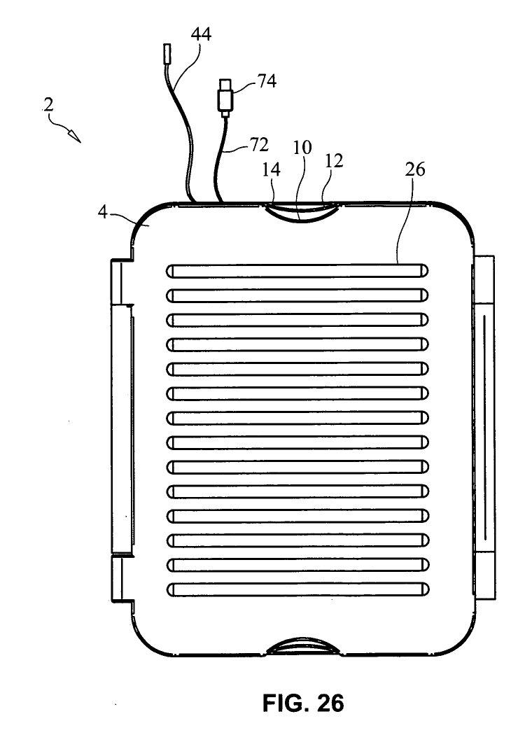

The signal receiving antenna 16 of the present invention may take on forms other than the loop or rectangular dipole antennas previously described, such as cloverleaf, spiral or more complex planar antennas. Such antennas most likely could not be confined to the cavity provided by the hoop-shaped third section 8. Accordingly, the third section 8 may be formed as a tray 82 or generally planar piece having an expanded interior cavity to accommodate such wider, spread out signal receiving antennas 16. Such a tray version of the laptop computer antenna device 2 is shown in FIGS. 19-26.

The tray version of the laptop computer antenna device 2 has substantially all of the same structure and components of the hoop version described previously, except that the central opening 36 defined by the rectangular hoop 9 is filled in or covered with a planar piece or tray 82 having a larger cavity formed therein than what was defined by the hoop 9 of the earlier version. Thus, the third section 8, which houses the signal receiving antenna 16, is generally planar in shape, and may include a continuous peripheral edge portion 84 extending downwardly from the lower surface thereof which may be received by a recess defined by a recessed portion 34 of the upper surface 32 of the middle section 6, in the same manner as the hoop 9 is received by the recess of the middle section 6 in the hoop version of the laptop computer antenna device 2 described previously, in order to allow the tray version of the antenna device 2 to fold into a compact form when not deployed for use. The third section 8 of the tray version provides additional interior space to house more complex signal receiving antennas 16 occupying greater surface areas than the dipole and loop antennas used in the hoop version of the laptop computer antenna device 2 of the present invention described earlier and shown in FIGS. 1-7. The components and structure of the tray version of the laptop computer antenna device 2 which are the same as or similar to the components and structure of the hoop version are designated in FIGS. 19-26 using the same reference numbers used for the hoop version.

Although illustrative embodiments of the present invention have been described herein with reference to the accompanying drawings, it is to be understood that the invention is not limited to those precise embodiments, and that various other changes and modifications may be effected therein by one skilled in the art without departing from the scope or spirit of the invention.

What is claimed is:

1. A laptop computer antenna device for use with a laptop computer and for receiving television broadcast signals, which comprises:
a bottom section having opposite upper and lower surfaces;
a middle section hingedly joined to the bottom section and positionable at an angle thereto, the middle section having opposite upper and lower surfaces;
a top section hingedly joined to the middle section and positionable at an angle thereto, the top section having opposite upper and lower surfaces; and
a signal receiving antenna, the signal receiving antenna being situated on the top section.

2. A laptop computer antenna device as defined by claim 1, wherein each of the bottom section, middle section and top section is generally planar in shape, the bottom section, middle section and top section being foldable to a compact state when the antenna device is not in use to receive television broadcast signals.

3. A laptop computer antenna device as defined by claim 2, wherein the top section has formed therein an interior cavity, the signal receiving antenna being situated within the interior cavity of the top section.

4. A laptop computer antenna device as defined by claim 3, wherein the top section is formed as a planar hoop, the hoop having the interior cavity formed therein, the signal receiving antenna being situated in the interior cavity of the hoop.

5. A laptop computer antenna device as defined by claim 4, wherein the upper surface of the middle section has formed therein a recess, the recess being dimensioned to at least partially receive the hoop of the top section.

6. A laptop computer antenna device as defined by claim 4, which further comprises:
a preamplifier, the preamplifier being mounted on one of the bottom section, the middle section and the top section, the preamplifier being responsive to a broadcast television signal received by the signal receiving antenna of the top section and providing an amplified broadcast television signal in response thereto.

7. A laptop computer antenna device as defined by claim 6, wherein the preamplifier includes a signal input port, the signal input port being connected to the signal receiving antenna of the top section, a signal output port, the signal output port providing the amplified broadcast television signal thereon, and a power input port.

8. A laptop computer antenna device as defined by claim 7, which further comprises:
a first electrical conductor, the first electrical conductor being in electrical communication with the signal receiving antenna of the top section and the signal input port of the preamplifier; and
a second electrical conductor, the second electrical conductor having a first end and an opposite second end, the first end of the second electrical conductor being electrically connected to the signal output port of the preamplifier, the second end of the second electrical conductor having a connector for connection to one of a power connector on a laptop computer and a power supplying device.

9. A laptop computer antenna device as defined by claim 1, wherein the bottom section has a first width, the middle section has a second width and the top section has a third width, each of the first width, the second width and the third width being at most equal to about twenty inches.

10. A laptop computer antenna device as defined by claim 1, which further comprises:
a pad mounted on the upper surface of the bottom section, the pad being formed of a laptop computer anti-slip material.

11. A laptop computer antenna device as defined by claim 1, which further comprises:
a plurality of parallel ribs extending from the lower surface of the bottom section.
